(19) United States
(12) Patent Application Publication
(10) Pub. No.: US 2022/0096308 A1
(43) Pub. Date: Mar. 31, 2022

(54) PLANTAR PRESSING DEVICE AND RELATIVE CONTROLLED MOBILIZATION APPARATUS

(71) Applicant: Leonardo OSTI, Modena (IT)

(72) Inventor: Leonardo OSTI, Modena (IT)

(21) Appl. No.: 17/426,074

(22) PCT Filed: Jan. 29, 2020
(86) PCT No.: PCT/IB2020/050705

§ 371 Date: Jul. 27, 2021

(30) Foreign Application Priority Data
Jan. 29, 2019 (IT) 102019000001319

(51) Int. Cl. A61H 1/02; A61H 15/00

(52) U.S. Cl. CPC A61H 1/0266; A61H 15/00; A61H 2201/1642; A61H 2201/5005; A61H 2201/1676; A61H 2201/5007; A61H 2201/0192; A61H 2015/0014

(57) ABSTRACT

A plantar pressing device comprises a supporting structure/component/unit/device/member of at least one foot of a patient comprising a resting portion of the sole of the foot; a pressing structure/component/unit/device/member associated with the resting portion and configured to abut against the sole of the foot and to stimulate the latter by exerting a pressing force.

### TECHNICAL FIELD

The present invention relates to a plantar pressing device and relative controlled mobilization apparatus.

### BACKGROUND ART

With particular reference to post-operative or post-traumatic musculoskeletal rehabilitation, plantar pressing devices are known which are adapted to contact the sole of a patient's foot to exert neuromuscular stimulation on the latter.

At the same time, the use of controlled mobilization apparatuses is known comprising holding means of a patient's lower limb and of a foot resting portion associated with the latter.

The holding means comprise a first arm adapted to hold the patient's thigh and a second arm pivoted onto the first arm itself and adapted to hold the patient's leg.

With one end of the second arm is associated the resting portion adapted to contact the sole of the patient's foot.

Such known apparatuses comprise actuating and rotating means adapted to move the resting portion around an axis of rotation. The rotation of the resting portion makes it possible to apply an external force to the patient's foot that determines the passive movement thereof.

These apparatuses do however have a number of drawbacks, one of which is that in order to carry out appropriate rehabilitation therapy it is necessary to combine the use of such mobilization apparatuses with the use of the pressing devices, thereby increasing operating and rehabilitation times.

In fact, the combined use of pressing devices with mobilization apparatuses significantly lengthens the time needed to position the patient, perform rehabilitation therapy and change devices.

In addition, the mobilization apparatuses perform a mere passive movement while neglecting other clinical issues related to patient staying in bed such as e.g. venous thrombolysis or post-operative oedema absorption.

### DESCRIPTION OF THE INVENTION

The main aim of the present invention is to devise a plantar pressing device and relative controlled mobilization apparatus that allow rehabilitation therapies to be carried out with a single apparatus, greatly shortening the operating times for both apparatus positioning assistance and rehabilitation.

Another object of the present invention is to devise a plantar pressing device and relative controlled mobilization apparatus that will significantly reduce the risk of venous thrombolysis also by shortening the time needed for post-operative oedema absorption.

A further object of the present invention is to devise a plantar pressing device and relative controlled mobilization apparatus which allows carrying out the active movement of the patient's foot by increasing the neuromuscular stimulations applied onto the foot compared to devices of known type.

Another object of the present invention is to devise a plantar pressing device and relative controlled mobilization apparatus which allows overcoming the aforementioned drawbacks of the prior art in the ambit of a simple, rational, easy, effective to use and low cost solution.

The objects set out above are achieved by the present plantar pressing device and relative controlled mobilization apparatus having the characteristics of claims 1 and 13.

### BRIEF DESCRIPTION OF THE DRAWINGS

Other characteristics and advantages of the present invention will be more evident from the description of a preferred, but not exclusive, embodiment of a plantar pressing device and relative controlled mobilization apparatus, illustrated as an indication, but not limited to, in the attached tables of drawings in which:

FIG. 1 is a side view of the device according to the invention;

FIG. 2 is a side view of the apparatus according to the invention;

FIGS. 3-5 are schematic representations of the apparatus according to the invention during the operation thereof;

FIG. 6 is a plan view of a portion of the apparatus according to the invention.

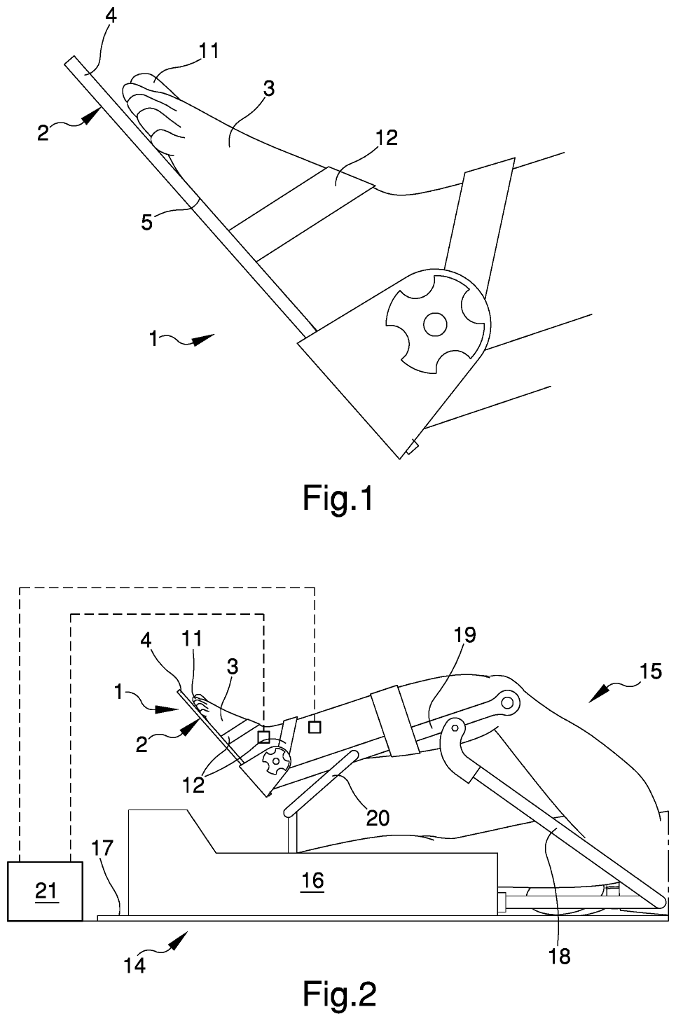

### EMBODIMENTS OF THE INVENTION

With particular reference to these figures, reference numeral 1 globally indicates a plantar pressing device.

The device 1 comprises supporting means 2 of at least one foot 3 of a patient comprising a resting portion 4 of the sole 5 of the foot itself.

With reference to the particular embodiment solution shown in the figures, the supporting means 2 comprise a single resting portion 4 of the patient's foot 3. It cannot however be ruled out from the scope of the present discussion that the device 1 may comprise two resting portions 4 for both feet 3 of the patient.

In addition, the device 1 comprises pressing means 6 associated with the resting portion 4 and configured to abut against the sole 5 of the foot 3 and to stimulate the sole by exerting a pressing force schematically represented in the figures with the arrow 8.

In accordance with a preferred embodiment, the pressing means 6 comprise a plantar arch device 7.

In this case, the pressing means 6 consist of a single monolithic body adapted to abut against the sole 5 of the foot 3 of the patient and to exert the above mentioned pressing force on the sole.

In an alternative embodiment, the pressing means 6 comprise a plurality of roller elements associated with the resting portion 4.

One aspect of fundamental importance consists in the positioning of the pressing means 6.

In this respect, the device 1 comprises positioning means of the pressing means 6, which are not shown in detail in the figures, associated with the resting portion 4 and adapted to allow the adjustment of the position of the pressing means 6 on the resting portion itself.

For example, the positioning means can be of the type of an actuator associated with one or more guides adapted to allow the movement thereof on the resting portion 4 and the temporary locking thereof in a preset position.

In addition, the device 1 comprises translation means for translating the pressing means 6 schematically shown in the figures with the arrow 9, associated with the resting portion 4 and adapted to vary the position of the pressing means 6 on the resting portion 4.

By way of example, the translation means can be of the type of an actuator associated with one or more guiding elements adapted to allow the movement thereof on the resting portion 4.

It cannot however be ruled out from the scope of the present discussion that the pressing means 6 consist of a single monolithic fixed body adapted to exert the aforementioned pressing force on the sole of the user's foot.

In order to vary the pressing force exerted on the sole 5 of the foot 3, the device 1 comprises variation means for varying the pressure exerted by the pressing means 6.

Preferably, the pressure variation means comprise a thrust actuator of the pneumatic type or, alternatively, of the electromechanical type.

Specifically, the aforementioned thrust actuator is configured to allow exerting the force pressing on the sole 5 of the foot 3 in an intermittent mode.

At the same time, in the case where the pressing means 6 consist of a plurality of roller elements, the latter can be moved according to the predefined pressure values described in detail below.

In this respect, in order to control and manage the pressure values applied to the pressing means 6 which are adapted to generate the pressing force, the device 1 comprises a management and control unit operatively connected to at least one of the pressure variation means and the translation means.

In detail, the management and control unit can be connected to the pressing means 6 or, alternatively, to the pressure variation means.

Advantageously, the management and control unit is configured to simultaneously control the pressure variation means and the translation means.

This makes it possible to carry out a synchronous movement between the translation of the pressing means 6, in the specific case of the plantar arch device 7, and the application of the pressure values according to the position of the plantar arch device itself on the resting portion 4.

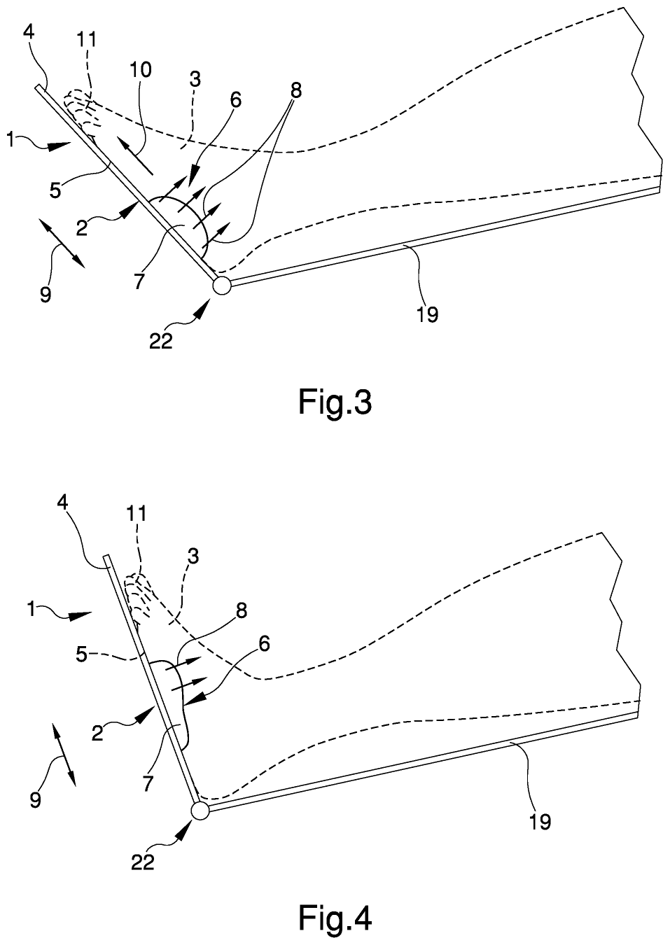

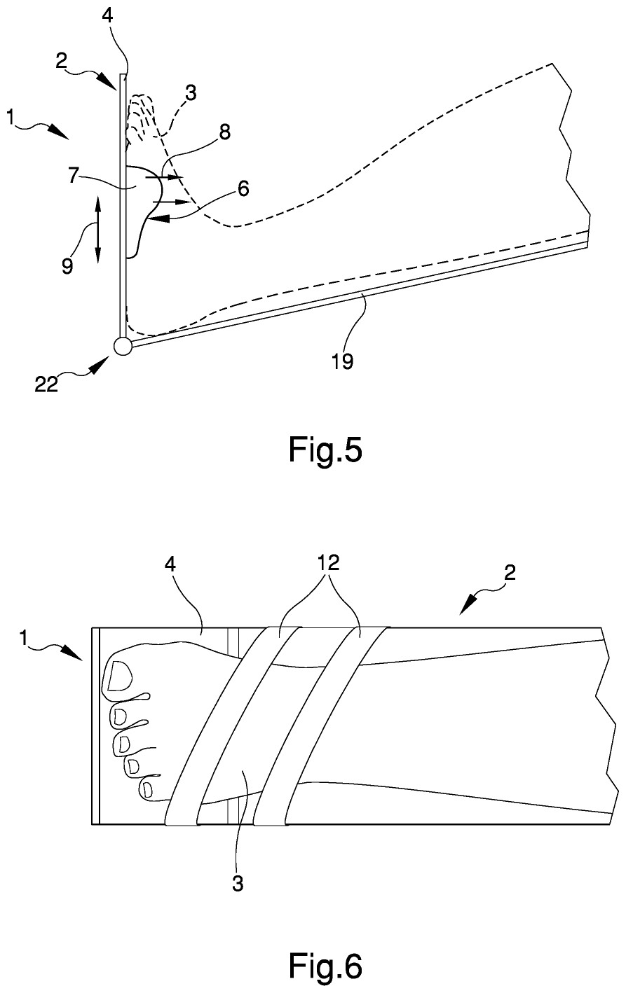

In practice, in a resting position, the plantar arch device 7 is positioned at the heel of the foot 3 (FIG. 3). Subsequently, the management and control unit commands the translation of the latter along a direction of translation, schematically shown in FIG. 3 with arrow 10, and oriented towards the toes 11 of the foot 3 (FIGS. 4 and 5). After having reached the toes of the foot 3, the plantar arch device 7 returns to the heel of the foot 3.

Simultaneously with the translation of the plantar arch device 7, the pressure variation means vary the pressure values exerted according to the position of the plantar arch device 7 itself during the relative displacement along the direction of translation 10.

For this purpose, the management and control unit comprises a storage unit which can be preset with the pressure values, the latter is configured to manage and control the pressure values applied to the pressing means 6, in this specific case the plantar arch device 7, depending on the position of the pressing means itself on the resting portion 4.

Preferably, the device 1 comprises fastening means 12 of the foot 3 to the resting portion 4.

Advantageously, the fastening means 12 comprise at least one ribbon element adapted to allow anchoring the foot 3 on the resting portion 4.

With reference to the particular embodiment shown in FIG. 5, the fastening means 12 comprise two ribbon elements.

The aforementioned ribbon elements 12 can be adjusted not only according to the size of the patient's foot 3, but also in order to exert neuromuscular stimulation on the surrounding muscles.

For this purpose, the device comprises angular adjustment means, not shown in detail in the figures, for the positioning of each of the ribbon elements 12 with respect to the foot 3.

Preferably, the resting portion 4 comprises a plurality of anchorage elements with which each ribbon element 12 is associable.

The above anchorage elements are positioned at predefined angular gradations.

The present invention also relates to a controlled mobilization apparatus 14.

The apparatus 14 comprises holding means 18, 19 for holding a portion of a lower limb 15 of the patient.

The holding means 18, 19 comprise a plurality of supporting arms pivoted together and associated with a base frame 16 for resting the apparatus itself on a surface 17.

In particular, the holding means 18, 19 comprise a first arm 18 for the support of the patient's thigh and a second arm 19 for the support of the patient's leg.

The first arm 18 and the second arm 19 are pivoted together at the ends to form a predefined width angle depending on the clinical and rehabilitation needs of the patient.

In particular, as shown in FIG. 2, the second arm 19 is associated with an anchorage element 20, which in turn is associated with the base frame 16 and adapted to allow the leg to be immobilized and kept at a predefined height from the surface 17.

In addition, the apparatus 14 comprises a movement assembly 21, 22 of the foot 3 associated with the holding means 18, 19.

According to the invention, the apparatus 14 comprises the pressing device 1.

More in detail, the device 1 is associated with one end of the second arm 19.

The apparatus 14 comprises synchronization means for synchronizing the movement assembly 21, 22 with respect to at least one of the translation means and the pressure variation means, the synchronization means being adapted to allow rotating the resting portion 4 in synchronization with at least one of either the translation of the pressing means 6 on the resting portion 4 or the pressure variation exerted by the pressure variation means on the pressing means 6.

Preferably, the synchronization means are adapted to allow rotating the resting portion 4 in synchronization with the translation of the pressing means 6 on the resting portion 4 and the pressure variation exerted by the pressure variation means on the pressing means 6.

In order to allow the control and management of the synchronization of the movements of the resting portion 4, of the translation means and of the pressure variation means, the synchronization means are operatively connected to the management and control unit 11.

In addition, the movement assembly 21, 22 comprises electro-stimulation means 21 configured to apply an electrical pulse onto at least one portion of the lower limb 15 so as to allow the active movement of the foot 3 due to the electrical pulse itself.

Preferably, the aforementioned portion is located in the proximity of the foot 3 of the patient.

It is specified that in the present treatise the expression “active movement” refers to the execution of a movement by means of muscle activation. In other words, reference is made to the variation in the angle of movement that is caused by the contractile activity of the skeletal muscles, which are inserted on the bone heads making up the joint.

In other words, the electrical pulse, acting on the muscles, determines the contraction thereof and therefore the movement of the foot.

The electro-stimulation means 21 are of the type known to the branch technician and comprise one or more electrodes applicable to the portion of the lower limb 15.

In addition, the apparatus 14 comprises actuating and rotating means 22 of the resting portion 4, not shown in detail in the figures, associated with the supporting means 2 and adapted to allow the passive movement of the foot 3.

It should be specified that in the present discussion the words “passive movement” mean the movement of the foot thanks to the application from the outside of a force that causes a variation in the joint angle. Specifically, this force is applied mechanically by the actuating and rotating means that accompany the foot 3 during the movement (FIGS. 3-5) of the resting portion 4.

It should also be noted that the electro-stimulation means 21 and the actuating and rotating means 22 are operatively associated with the management and control unit 11.

Before the detailed explanation of the operation of the present invention, it is worthy to emphasize that the apparatus 14 can be provided with a wireless device adapted to allow the control and management thereof also remotely.

The operation of the present invention is as follows.

The patient places their foot 3 on the resting portion 4.

An operator, acting on the positioning means, places the pressing means 6 in a suitable position for the application of the pressing force (arrow 8). This position is determined according to the size of the patient's foot 3.

The management and control unit activates the operation of the device 1 and, synchronously, of the movement assembly 21, 22.

In detail, starting from the resting position (FIG. 3), the management and control unit determines the displacement of the pressing means, in this case the plantar arch device 7, along the direction of translation 10.

The plantar resting portion 4 in the resting position (FIG. 3) defines an angle with the second arm 19 having a predefined width.

The actuating and rotating means 22 actuate in rotation the resting portion 4 which, by carrying out a circular motion, decreases the width of the angle formed with the second arm 19 (FIGS. 4 and 5).

At the same time, during the movement of the resting portion 4, the pressure variation means apply the pressure values previously stored on the storage unit on the plantar arch device 7 which travels in the direction of translation 10.

In detail, these pressure values are applied according to the position of the plantar arch device 7 on the resting portion 4.

In practice, the plantar arch device 7 displaces onto the resting portion 4 and, in combination with the rotation of the resting portion 4, stimulates the foot 3 from the neuromuscular point of view, thus simulating a load substantially equal to that of walking in a vertical position.

Even more in detail, the application of different pressure values on the plantar arch device 7 and the displacement thereof along the direction of translation 10 towards the toes 11 determines the deformation thereof due to the application of the pressure values themselves.

Once the toes 11 have been reached, the pressing device 1 and the resting portion 4 go back to the respective initial positions (FIG. 3). In other words, the pressing device 1 travels along the direction of translation 10 going back to the patient's heel, and the resting portion 4 redefines the initial angle with the second arm 19.

In detail, the activation of the actuating and rotating means 22 allows carrying out a passive movement of the foot; in fact, the resting portion 4 accompanies the foot 3 in rotation.

At the same time, the management and control unit activates the electro-stimulating means which, by applying an electrical pulse to the lower limb 15, in this case to the leg in the proximity of the foot 3, determine the muscle contraction of the same and the active movement of the foot 3.

It has in practice been ascertained that the described invention achieves the intended objects.

In particular, it should be noted that the special solution of providing for the synchronous movement of the translation means, of the pressure variation means, of the electro-stimulating means and of the actuating and rotating means allows stimulating the foot from the neuromuscular point of view, simulating the load of the walk in a vertical position.

In addition, the aforementioned synergistic combination allows reducing the risk of venous thrombolysis; in detail, the fact that the plantar arch device travels along a direction of translation oriented towards the toes promotes blood circulation. In fact, it should be noted that the direction of translation of the plantar arch device is substantially coincident with the direction of extension of the foot veins.

1) A plantar pressing device comprising:
supporting means of at least one foot of a patient comprising a resting portion of the sole of said foot;
pressing means associated with said resting portion and configured to abut against the sole of said foot and to stimulate the latter by exerting a pressing force.

2) The plantar pressing device according to claim 1, further comprising: positioning means of said pressing means associated with said resting portion and adapted to allow the adjustment of the position of said pressing means on said resting portion.

3) The plantar pressing device according to claim 1, further comprising: translation means for translating said pressing means associated with said resting portion and adapted to vary the position of said pressing means on said resting portion.

4) The plantar pressing device according to claim 1; further comprising: variation means for varying the pressure exerted by said pressing means.

5) The plantar pressing device according to claim 1, further comprising: at least one management and control unit operatively connected to at least one of said pressure variation means and said translation means.

6) The plantar pressing device according to claim 5, wherein said management and control unit is configured to simultaneously command said pressure variation means and said translation means.

7) The plantar pressing device according to claim 5, wherein said management and control unit comprises at least one storage unit which can be preset with said pressure values, the latter being configured to manage and control said pressure values applied to said pressing means according to the position of said pressing means on said resting portion.

8) The plantar pressing device according to claim 1, wherein said pressing means comprise a plurality of roller elements associated with said resting portion and movable according to said pressure values.

9) The plantar pressing device according to claim 1, wherein said pressing means comprise a plantar arch device.

10) The plantar pressing device according to claim 1, further comprising: fastening means of said foot to said resting portion.

11) The plantar pressing device according to claim 10, wherein said fastening means comprise at least one ribbon element adapted to allow anchoring said foot on said resting portion.

12) The plantar pressing device according to claim 1, further comprising: angular adjustment means for the positioning of said at least one ribbon element with respect to said foot.

13) A controlled mobilization apparatus, comprising:
holding means of a portion of a lower limb of a patient;
at least one movement assembly of a foot associated with said holding means; and
said plantar pressing device according to claim 1 and associated with said holding means.

14) The controller mobilization apparatus according to claim 13, further comprising: synchronization means for synchronizing said movement assembly with respect to at least one of said translation means and said pressure variation means, said synchronization means being adapted to allow rotating said resting portion in synchronization with at least one of the translation of said pressing means on said resting portion and the pressure variation exerted by said pressure variation means on said pressing means.

15) The controlled mobilization apparatus according to claim 14, wherein said synchronization means are adapted to allow rotating said resting portion in synchronization with the translation of said pressing means onto said resting portion and the pressure variation exerted by said pressure variation means on said pressing means.

16) The controlled mobilization apparatus according to claim 14, wherein said synchronization means are operatively connected to said management and control unit.

17) The controlled mobilization apparatus 14, according to one claim 13, wherein said movement assembly comprises electro-stimulation means configured to apply an electrical pulse onto at least one portion of said lower limb so as to allow the active movement of said foot due to said pulse.

18) The controlled mobilization apparatus according to claim 13, wherein said movement assembly comprises actuating and rotating means of said resting portion of said foot, associated with said supporting means and adapted to allow the passive movement of said foot.
